(19) United States
(12) Patent Application Publication
(10) Pub. No.: US 2005/0086133 A1
(43) Pub. Date: Apr. 21, 2005

(54) System and method for sensing and analyzing inventory levels and consumer buying habits

(76) Inventors: William H. Scherer, Kennesaw, GA (US); Ronald L. Bane, Saginaw, TX (US)

Correspondence Address: WEATHERLY KERVEN LLC, 3330 CUMBERLAND BOULEVARD, SUITE 500, ATLANTA, GA, 30339-5985, US

(21) Appl. No.: 10/755,055

(22) Filed: Jan. 8, 2004

Related U.S. Application Data
(60) Provisional application No. 60/438,733, filed on Jan. 8, 2003.

(51) Int. Cl. G06F 17/60

(52) U.S. Cl. 705/28

(57) ABSTRACT

The invention relates to a system and methods for sensing and analyzing inventory levels and consumer buying habits. The system includes a sensor pad that can be easily installed on a display shelf by simply resting the panel on the shelf. Sensors are mounted inside the sensor pad that are hardwired to circuitry collectively called a smart hub. The hub is a programmable device with an integrated paging transceiver for communicating with a remotely located server that is managed by the inventory sensing service provider. The hub periodically transmits a report, which is highly configurable, to the service provider's server, preferably as a text message over the paging network, which arrives at a service provider's server after being converted to an e-mail. This server converts the information in the reports into inventory data and stores this data in a database that customers of the inventory service can access remotely. The server also generates reports reflecting inventory data and consumer purchasing behavior for the various display racks equipped with a smart hub.

### I. RELATED APPLICATIONS

This application claims the benefit of U.S. Provisional Application No. 60/438,733 filed Jan. 8, 2003, which is incorporated here by this reference.

### II. BACKGROUND OF THE INVENTION

The present invention relates to systems used to sense inventory levels, gather information about purchasing habits, and analyze and report the information to distribution and marketing personnel. More specifically, the invention relates to systems and methods that are particularly suited for the beverage industry. The systems and methods involve gathering information about the number or volume of an inventory item on retail display, reporting the information to a remotely located computer, analyzing the information received by the computer, and reporting meaningful information to Inventory and/or marketing personnel.

Consumer product companies are faced with a number of issues related to marketing their products. One aspect of product marketing is merchandising of the products. Merchandising is actually placing the consumer good in retail outlets in a place where consumers will buy the product. Many consumer product companies place their equipment (i.e., display racks, shelf units) in a variety of places within the store and also place point of purchase (P-O-P) advertising in various locations to draw customer's attention to the product in hopes they will purchase the product. Consumer goods manufacturers need a reliable methodology for measuring the effectiveness of their “at-retail” merchandising and P-O-P activities. Companies and their marketing and brand groups are often faced with guessing as to the effectiveness of their in store merchandising. Point-of-sales scanning of UPC labels at the checkout can provide useful information as to the sales of items. But cash register sales do not provide information, for example, about where the product was purchased within a store, what shelf was it bought from, what was the inventory on the shelf, or did the consumer have to reach to the back or reach to a lower shelf because stock was out in the center of the display space. Knowing this information will help consumer goods managers make better decisions on merchandising and even distribution of their products.

Methods employed to date to try to gather this information have included physical observation, distributor tracking, and targeted UPC labels. Other technologies have sought to monitor the inventory of products by means of mechanical scales, electrical shelf arrays for binary sensing of individual items, and optical counting. These systems had to be built into the display and were cumbersome to implement without affecting the buying habits of the consumer. In addition, the analog information or digital information employed often required a wired network connection.

Other methods used to gather merchandising data also have inherent difficulties. Physical observation is difficult and expensive because it would involve a person keeping watch during the entire time a store is open and recording the data. Even if video taping the display, a person would need to be employed to record the consumer behaviors observed on the tape. Using the distributor is problematic as well because it requires the distributor to be properly motivated continuously to supply accurate recording in each shelf. The distributor's drivers change often, and the drivers' priorities are in delivering product, not recording accurate data. Therefore, data gathered through a distributors' drivers is often inaccurate and sketchy. Finally UPS label tracking does provide accurate results of products being bought, but this requires a great deal of coordination both with the retail chain and the distributors. First the store chain must set their data systems to account for the separate UPC label and then they must also provide separate stocking areas and inform store personnel on how to load shelving with the appropriate products. The distributor and manufacturer must also be involved in printing separate labels and producing a relatively small production run of the labels. Further they must deliver and stock the merchandising shelves correctly on a consistent basis. This method provides opportunity for errors and is difficult and expensive to coordinate.

Knowing where products are purchased in a store is valuable to the consumer goods manager for a variety of reasons. Perhaps they want to test multiple displays in a store, different types or different looks. To provide valuable information to the consumer goods manager, one must be able to provide data about what was bought and when. The consumer goods manager may want to test the effectiveness of a graphic or other advertising vehicle to cause a “look” reaction at the shelf or where the best place to merchandise their product is located. Distributors often pay slotting fees, and some retailers require distributors to pay a premium for placing the distributor's goods in the prime locations within the retail locations. When a consumer goods manager knows where the best retailing locations are in a retail outlet, he can better optimize his spending on slotting fees.

### III. SUMMARY OF THE INVENTION

The system and methods of the invention for sensing and analyzing inventory levels and consumer buying habits avoid many of the problems associated with prior methods. The system is easily installed by personnel having relatively minimal training without the need to connect equipment to infrastructure in the retail location other than conventional AC power. The system includes a sensor pad that can be easily installed on a display shelf by simply resting the panel on the shelf. Sensors are mounted inside the sensor pad that are hardwired to circuitry collectively called a smart hub. The hub is a programmable device with an integrated paging transceiver for communicating with a remotely located server that is managed by the inventory sensing service provider. The hub may also be programmed to poll the sensors in the sensor pad at periodic intervals and gather and store the responsive sensor information. The smart hub is also programmed to generate a report, which is highly configurable, and transmit that report to the service provider's server, preferably as a text message on the paging network. The paging service preferably converts that text paging message into an e-mail and forwards the e-mail to the service provider's server. This server receives reports from all smart hubs deployed that are programmed to send messages to that server. As the server receives these e-mail reports from the smart hubs, it converts the information in the reports into inventory data and stores this data in a database that customers of the inventory service can access remotely. The server also generates its own reports based on information gathered over time from each smart hub with which it is associated. These reports can be sent periodically or on demand via any number of conventional communication methods including e-mail, a pager message, an automated voice mail, or even paper.

The foregoing general description and the following detailed description are exemplary and explanatory only and do not restrict the claims directed to the invention. The accompanying drawings, which are incorporated in and constitute a part of this specification, illustrate exemplary embodiments portions of systems and methods according to the invention and together with the description, serve to explain the principles of the invention.

### IV. BRIEF DESCRIPTION OF THE DRAWINGS

FIG. 1 is a schematic diagram illustrating a system according to the invention for sensing and analyzing the inventory of items on a display rack.

FIG. 2A is a schematic perspective view of the display rack shown in FIG. 1.

FIG. 2B is a cross sectional view taken along lines 2B-2B of FIG. 2 which schematically illustrates weight sensing hardware integrated into the display rack.

FIG. 2C is an enlarged view of the portion of FIG. 2C within the dashed box labeled FIG. 2C, which illustrates one of the weight sensors shown in FIG. 2B.

FIG. 2D is a schematic perspective illustrating a stand-alone sensor pack for use in the system according to the invention.

FIG. 2E is plan view taken of the sensor pack illustrated in FIG. 2D with the top panel removed to reveal the sensors inside the pack.

FIG. 2F is an enlarged cross sectional view of the sensor pack taken along lines 2F-2F of FIG. 2D illustrating some of the sensor components inside the pack.

FIG. 3A is a schematic layout of a smart hub in the system according to the invention that polls the sensors deployed in the display rack and generates and transmits messages to the computer in the data center regarding the sensor data collected.

FIG. 3B is a schematic diagram illustrating a smart hub according to the invention having multiple circuit boards that control the sensor input/output and multiplexing linked together to increase the number of sensors for which the smart hub shown in FIG. 3A can report data.

FIG. 3C is a schematic circuit board layout for a circuit board that primarily performs the multiplexing function of the sensor input/output and multiplexing block functionally depicted in FIG. 3A.

FIG. 3D is a schematic circuit board layout for a circuit board that primarily performs the sensor input/output function of the sensor input/output and multiplexing block functionally depicted in FIG. 3A.

FIG. 3E is a schematic circuit board layout for a circuit board that provides power to all circuit boards in the smart hub and an physical data interface between the data communications board and the sensor input/output and multiplexing boards functionally depicted in FIG. 3A.

FIG. 4 is a flow diagram of the steps taken by the server at a data center in a system according to the invention in response to a communication from a display rack hub in the system according to the invention.

### V. DETAILED DESCRIPTION OF THE INVENTION

This application refers in detail below to the systems and methods of sensing and analyzing inventory levels and consumer buying habits, which are illustrated in the accompanying drawings. Wherever possible, the application uses the same reference numbers throughout the drawings to refer to the same or similar items.

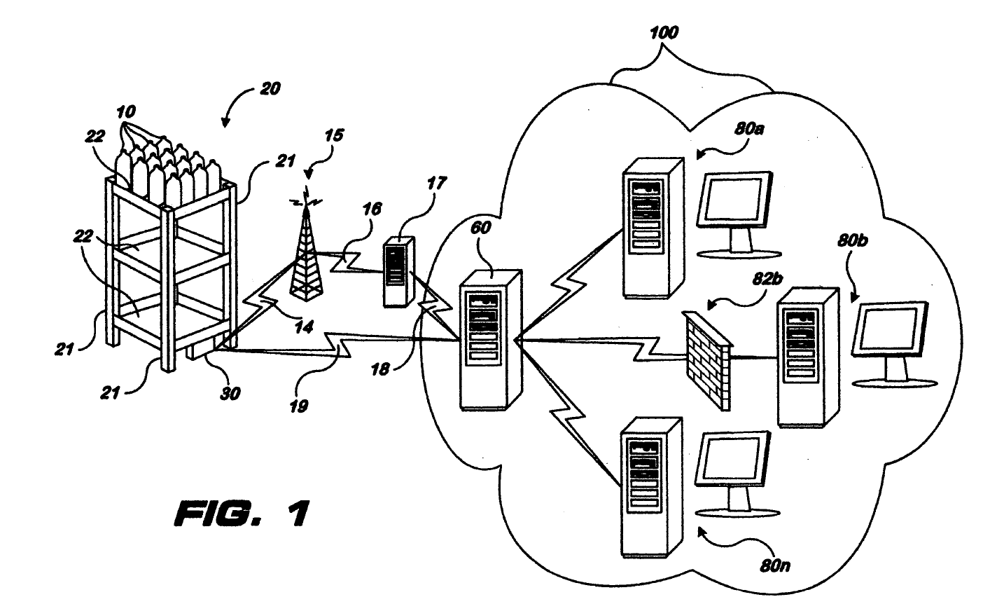

FIG. 1 schematically illustrates a system according to the invention for sensing and analyzing inventory levels of items 10 resting on sensor pads 22 on the shelves 23 of a display rack 20 and consumers' purchasing habits relating to those items 10. Display rack 20 includes a smart hub 30 which collects and records data from sensors deployed to measure a characteristic of items 10 on sensor pads 22, such as total weight. The smart hub 30 also generates and transmits the information reflecting the collected sensor data to a server 60 that is controlled by the company operating the system of the invention. The smart hub 30 can transmit this data at a configurable time interval, for example, as a text message over a wireless paging network. Such a message would be transmitted from smart hub 30 via path 14 to wireless base station 15. The wireless base station 15, would relay the message via path 16 to the paging provider's server 17. The server 17 could convert the text message into an e-mail and forward that e-mail message to the system operator's server 60. When the smart hub 30 uses a wireless communication path to server 60, the service provider can install all the hardware on an existing display rack without having to install network wiring or/or telephony connections or coordinate with information technology personnel in the retail location. Alternatively, the smart hub 30 can send this information to server 60 via a wired network using, for example, an Ethernet connection, a dial-up connection, or any other wired connection to the wide-area-network (WAN) 100. As described in more detail in Tables 1-3 below, the smart hub 30 sends information in a report format (Table 1) that includes numerous individual data fields (Table 2) which include, among other information, a voltage value read from each sensor in a display rack 20, the time at which each the sensor reading was recorded, and the identity of the sensor read and the display rack 20 on which the sensors are mounted.

Table 1 reflects an exemplary report format that can be generated by a smart hub 30. All fields depicted in this example other than “Serial Number” and “Board Number” can be selected for inclusion or exclusion from the report. For every smart hub 30, information about the format selected for the report is stored in a Radio Profiles database 67 (FIG. 4) stored on server 60. The smart hub report format may be altered remotely by sending a message from the server 60 to the smart hub 30. When such a remote alteration is performed, the Radio Profiles database is updated to reflect the new format.

TABLE 1
Report Format

| Line/Field | 1 | 2 | 3 | 4 | 5 | 6 | 7 | . . . 64 |
|---|---|---|---|---|---|---|---|---|
| 1 | Serial | Board | Time[8] | Temp | Channel | Channel | Supply[*7] | |
| | Number[10] | Number[1] | | Sensor[*7] | 1[*6] | 2[*6] | | |
| 2 | Time[8] | Temp | Channel | Channel | Channel | Channel | Reference[*6] | |
| | | Sensor[*7] | 1[*6] | 2[*6] | 3[*6] | 4[*6] | | |
| 3 | Sensor 0[4] | Sensor 1[4] | Sensor 2[4] | Sensor 3[4] | Sensor 4[4] | Sensor 5[4] | Sensor 6[4] | |

Table 2 contains definitions of the structure of all possible fields available for inclusion in a smart hub report along with exemplary ranges and values for each field.

TABLE 2
Field Detail

| | Number | | | | | |
|---|---|---|---|---|---|---|
| Field Name | Chars | Char Type | Format | Range | Example | Notes |
| Serial Number | 10 | AlphaNumeric | “##########” | | 50A3220074 | Assigned by Manufacturer of |
| | | | | | | CreatALink |
| Board Number | 1 | Numeric | “#” | 1-8 | 1 | Relative position in daisy chain |
| Time | 8 | Hex Alpha | “HHHHHHHH” | 00000000-FFFFFFFF | 0793FEC9 | Number of seconds since |
| | | | | | | 00:00:00 Jan 1, 2000 where all |
| | | | | | | months have 31 days |
| Temp Sensor | 7 | Numeric | “##.##” | −40.00-85.00 | 35.00 | Temperature in degrees C. - |
| | | | | | | 0.25 degrees resolution |
| Channel 1 | 6 | Numeric | “#.###” | 0.000 to 2.500 | 1.466 | Voltage at A/D #1 on |
| | | | | | | CreatALink or Extender Board |
| Channel 2 | 6 | Numeric | “#.###” | 0.000 to 2.500 | 0.097 | Voltage at A/D #2 on |
| | | | | | | CreatALink or Extender Board |
| Channel 3 | 6 | Numeric | “#.###” | 0.000 to 2.500 | 0.000 | Voltage at A/D #3 on Extender |
| | | | | | | Board |
| Channel 4 | 6 | Numeric | “#.###” | 0.000 to 2.500 | 0.000 | Voltage at A/D #4 on Extender |
| | | | | | | Board |
| Supply | 6 | Numeric | “#.###” | 0.000 to 9.999 | 6.042 | Voltage Supplied to CreatALink |
| Reference | 6 | Numeric | “#.###” | 0.000 to 2.500 | 1.195 | Internal Reference to A/D on |
| | | | | | | Extender Board |
| Sensor X | 4 | Hex Alpha | “HHHH” | 0000-FFFF′ | 8258 | Bits 15-10 = Sensor # ranging |
| | | | | | | 0-63. Bits 9-0 = A/D reading |

Table 3 illustrates some exemplary time and sensor voltage calculations based on hexadecimal data received from a smart hub.

TABLE 3
Example Calculations

| | | Number of seconds since 00:00:00 | | | | | |
|---|---|---|---|---|---|---|---|
| Time Format | | Jan 1, 2000 where all months have 31 days | | | | | |
| Output | Total Seconds | years | month | day | hour | minute | second |
| 0793FEC9 | 127139529 | 3 | 12 | 15 | 12 | 32 | 9 |

Sensor X Format

| Output | Sensor # | Voltage |
|---|---|---|
| 8258 | 32 | 1.466 |

Once the sensor information arrives at the server 60, the server 60 processes and analyzes the sensor information so that a customer of the system operator can obtain reports regarding the current status of inventory levels on display racks 20 having items 10 being sold by that customer. The discussion below in connection with FIG. 4 explains this process in more detail. The customer can also see a report that indicates any trends in variation of the inventory level on each shelf 23 on display rack 20. The customer can access server 60 directly as desired via an internet browser or other client software using any conventional communications protocol (e.g., TCP/IP) and client-server protocol (e.g., FTP and HTTP) running on any one of workstations 80a, 80b, . . . 80n. When connecting via the internet a customer may also secure its own data on workstation 80b behind a firewall 82b. Alternatively, the server 60 can send reports at a desired interval to the customer via e-mail, pager, voice mail, automated telephone notification, or any other messaging technique that can be initiated in an automated fashion by server 60. Because the system according to the invention continually captures and reports real-time inventory levels for individual “shelf” locations on individual display racks, a distributor of the items 10 can optimize its point-of-purchase advertising spending and tune its restocking operations.

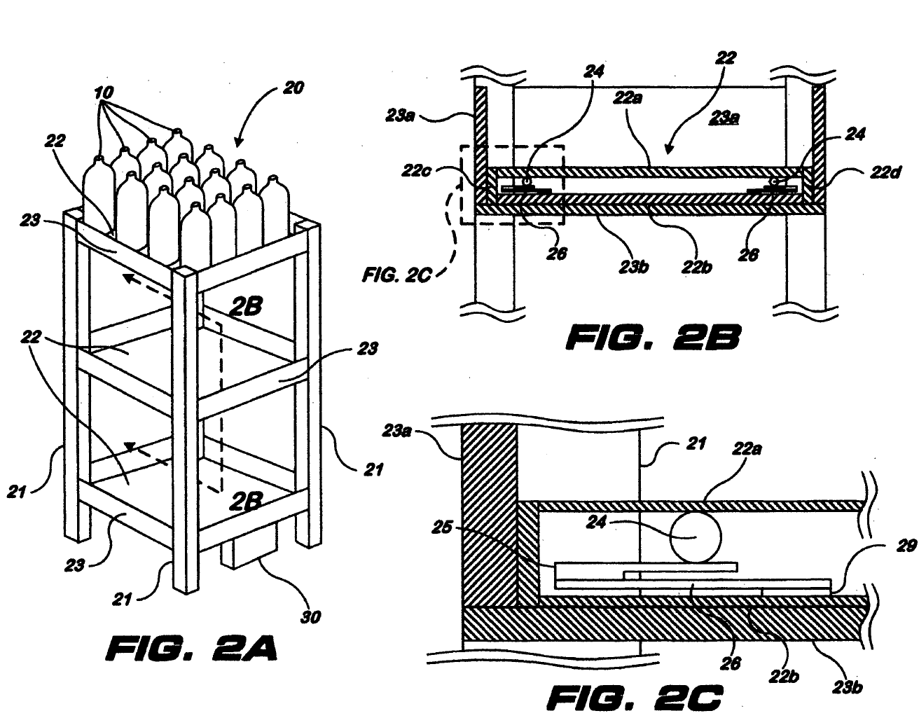

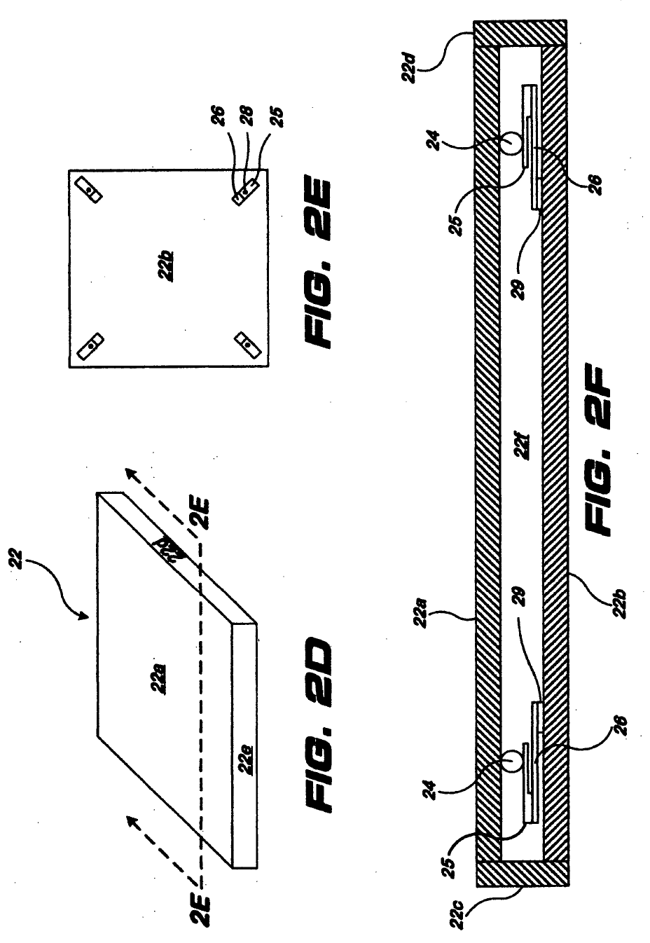

The display rack 20 and sensors 26 are shown in more detail in FIGS. 2A-2F with the entire display rack 20 holding numerous inventory items 10 (e.g., beverage bottles) and having legs 21, sensor pads 22, shelves 23, and a smart hub 30. FIG. 2D illustrates the sensor pad 22 removed from its mounting position on a shelf 23 of the display rack 20. FIG. 2B is a cross sectional view of a sensor pad 22 mounted on shelf 23 that is taken along line 2B-2B of FIG. 2A that illustrates the interior of a sensor pad 22 containing, among other items, sensors 26 and load transfer bearings 24. FIG. 2E is also a cross sectional view of sensor pad 22 (not mounted on a shelf 23 of display rack 20), but taken along line 2F-2F of FIG. 2D. Suitable sensors should be able to measure forces of up to 50 pounds and preferably forces of up to 100 pounds within +/− about 2% and preferably within +/− 1% or less. Advanced Custom Sensors, Inc. of Irvine, Calif. currently offers at least two sensors suited for use in display rack 20 including the Model 6000—Thin Film, Planar-Beam Force Sensor and the Model 6010—Foil-Gauge, Planar-Beam Force Sensor. The electrical, mechanical and operating specifications of the sensor Models 6000 and 6010 as published by Advanced Custom Sensors, Inc. are shown below in Tables 4 and 5 respectively.

TABLE 4
Model 6000 Specifications

| | |
|---|---|
| Electrical: | |
| Excitation Voltage (Vdc or Vac, rms) | 10 nominal, 15 maximum |
| Input Resistance (ohm) | 1200 ± 300 |
| Output Resistance (ohm) | 1200 ± 300 |
| Insulation Resistance (Mohm) | 1000 minimum @ 50 Vdc |
| Bridge Configuration | Full Wheatstone Bridge |
| Electrical Connection | 12″ of 30 AWG Shielded Cable |

Sensor Operating Characteristics:

| Capacity (lbf) | 0.25 | 0.5 | 1 | 2 | 5 | 10 | 20 | 40 | 50 |
|---|---|---|---|---|---|---|---|---|---|
| Full Scale (mV/V) | 1.5 ± 0.4 | 2 ± 0.4 | 2 ± 0.4 | 2 ± 0.4 | 2 ± 0.4 | 2 ± 0.4 | 2 ± 0.4 | 2 ± 0.4 | 2 ± 0.4 |
| Zero Balance (% FS)¹ | ±15 | ±15 | ±15 | ±15 | ±15 | ±15 | ±15 | ±15 | ±15 |
| Static Accuracy (% FS)² | 0.25 | 0.25 | 0.25 | 0.25 | 0.25 | 0.25 | 0.25 | 0.25 | 0.25 |
| Safe Overload (% FS)³ | 150 | 150 | 150 | 150 | 150 | 150 | 150 | 150 | 150 |
| Environmental Effects: | | | | | | | | | |
| Seal | Polyurethane Oligomer Mixture | | | | | | | | |
| Compensated Temperature Range | 20° F. to 120° F. | | | | | | | | |
| Operating Temperature Range | −65° F. to 200° F. | | | | | | | | |
| Temperature Effect on | | | | | | | | | |
| Zero Balance (% FS/° F.) | ±0.02 | ±0.02 | ±0.02 | ±0.02 | ±0.02 | ±0.02 | ±0.02 | ±0.02 | ±0.02 |
| Full Scale (% FS/° F.) | ±0.02 | ±0.02 | ±0.02 | ±0.02 | ±0.02 | ±0.02 | ±0.02 | ±0.02 | ±0.02 |
| Mechanical: | | | | | | | | | |
| Material | Stainless Steel | | | | | | | | |
| Thickness (in) | 0.004 | 0.005 | 0.009 | 0.012 | 0.020 | 0.028 | 0.040 | 0.056 | 0.063 |

Notes:
¹Zero balance may change with installation.
²Static accuracy is the RSS of non-linearity, hysteresis, and non-repeatability.
³Safe overload is guaranteed in reverse bending mode.

TABLE 5
Model 6010 Specifications

| | |
|---|---|
| Electrical: | |
| Excitation Voltage (Vdc or Vac, rms) | 5 nominal, 6 maximum |
| Input Resistance (ohm) | 350 ± 50 |
| Output Resistance (ohm) | 350 ± 50 |
| Insulation Resistance (Mohm) | 2000 min @ 50 Vdc |
| Bridge Configuration | Full Wheatstone Bridge |
| Electrical Connection | 8″ of Four 29 AWG |
| | Unshielded Cables |

Sensor Operating Characteristics:

| | | |
|---|---|---|
| Range (lbf) | 50 | 100 |
| Full Scale (mV/V) | 1.6 ± 0.16 | 1.6 ± 0.16 |
| Zero Balance (% FS)¹ | ±1 | ±1 |
| Static Accuracy (% FS)² | 0.1 | 0.1 |
| Safe Overload (% FS)³ | 150 | 150 |

Environmental Effects:

| Seal | Polyurethane Oligomer Mixture | |
|---|---|---|
| Operating Temperature Range | 14° F. to 122° F. (−14° C. to | |
| | 50° C.) | |
| Temperature Effect on | | |
| Zero Balance (% FS/° F.) | ±0.012 | ±0.012 |
| Full Scale (% FS/° F.) | ±0.006 | ±0.006 |
| Mechanical: | | |
| Material | Stainless Steel | |
| Thickness (in) | 0.071 | 0.098 |

Notes:
¹Zero balance may change with installation.
²Static accuracy is the RSS of non-linearity, hysteresis, and non-repeatability.
³Safe overload is guaranteed in reverse bending mode.

FIGS. 2C and 2F illustrate in more detail the mounting arrangement of sensors 26. As shown, the sensor beam 26 is mounted in cantilever fashion with a portion of its bottom surface resting on spacer 29. Another spacer 25 is mounted to a portion of the top surface of sensor beam 26 on the end opposite the location at which the spacer 29 contacts sensor 26. The load from items 10, which rest on top panel 22a of sensor pad 22, is transferred from top panel 22a to bearing 24 and then to the top surface of spacer 25. This arrangement is recommended by Advanced Custom Sensors, Inc. to avoid problems associated with side loading and off-center loading effects when sensor beams 26 are used to measure compression loads as in FIGS. 2B and 2C.

FIG. 2E depicts a sensor pad 22 with the top panel 22a and the side walls (22c, 22d, 22e, and 22f) removed to expose an exemplary mounting arrangement of four sensor beams 26 on the top surface of bottom panel 22b of sensor pad 22. The side walls 22c and 22d of the sensor pad 22 are connected to the top and bottom panels 22a and 22b of sensor pad 22 such that the load on the top panel 22a is not born by the ends of the side walls 22c, 22d, 22e, and 22f. Top and bottom panel 22a is made of high strength material so that it transfers the load imposed by items 10 as efficiently as possible and distributes the load as evenly as possible to the underlying sensor beams 26. For example, a top panel 22a made of Aluminum that is 0.125 inches thick is suitable.

FIG. 2E further depicts four evenly distributed sensor beams 26 mounted near the corners of bottom panel 22b. However, as few as one sensor beam 26 could be used in sensor panel 22 if the expected load were within limits and the size of the top and bottom panels 22a and 22b of sensor pad 22 were not too large. As the loaded area and expected load increase, the number of sensor beams 26 mounted inside sensor pad 22 should increase. When at least three sensor beams 26 are mounted inside sensor pad 22, the sensor beams themselves can define a stable load bearing plane on which all the load placed on top of sensor pad 22 can be born. Additionally, the readings from the set of sensor beams 26 in one sensor pad 22 can be compared with one another to estimate how the items 10 are distributed atop the top panel 22a of sensor pad 22. The total number of items 10 on the sensor pad 22 can be more accurately determined when at least three and preferably at least four sensor beams 26 are mounted in sensor pad 22 because the load sensed by each sensor beam 26 can be compared and/or averaged with the load measured by the other sensor beams 26 in a particular sensor pad 22.

While the beam sensors 26 are illustrated as being mounted inside a sensor pad 22 in a configuration suited for measuring a compression load, the sensors may be deployed in other locations. For example, a single beam sensor 26 could be mounted in a paddle shaped structure that could easily be positioned under a wheel of a vending machine or the leg of a display rack. The beam sensor could also be positioned at the front end of a row in a chilled display case that is designed to hold beverages single file with the beverages sliding forward when a consumer removes a bottle from the case or rack.

The system of the invention may also be configured to use types of sensors other than the solid beam force sensors discussed above. For example, the system may include sensors made using a of pressure sensitive ink applied to a durable paper backing that is mounted in the display rack with shims to transfer loads to the ink strip. These ink-based sensors are much less expensive than the beam sensors and could be deployed in much greater numbers to achieve reliability through redundancy and potentially gather data from individual item slots on a display shelf. Some of these alternative mounting arrangements and sensor types are discussed in the provisional patent application to which this application claims priority and incorporates by reference.

A. Multiplexer Board 54a

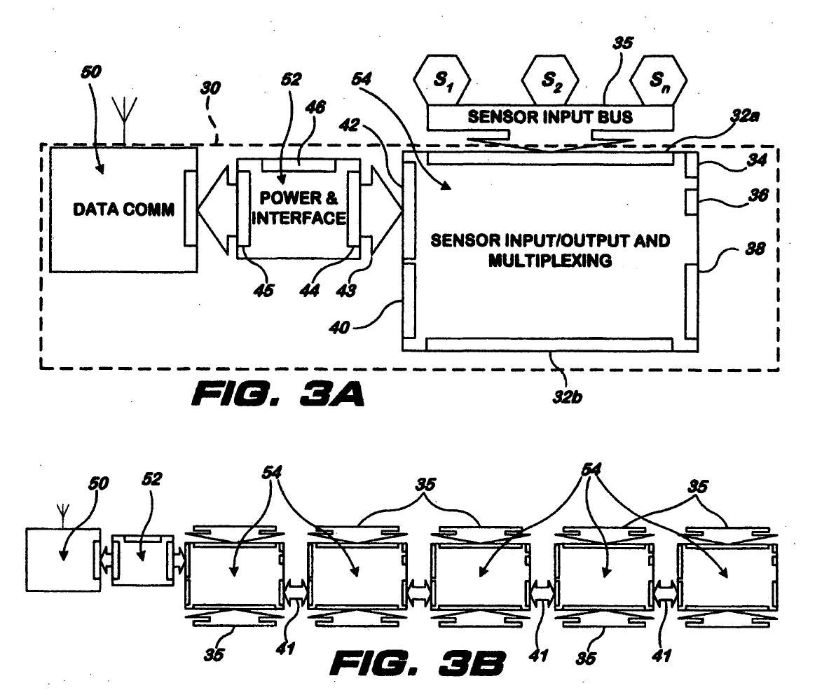

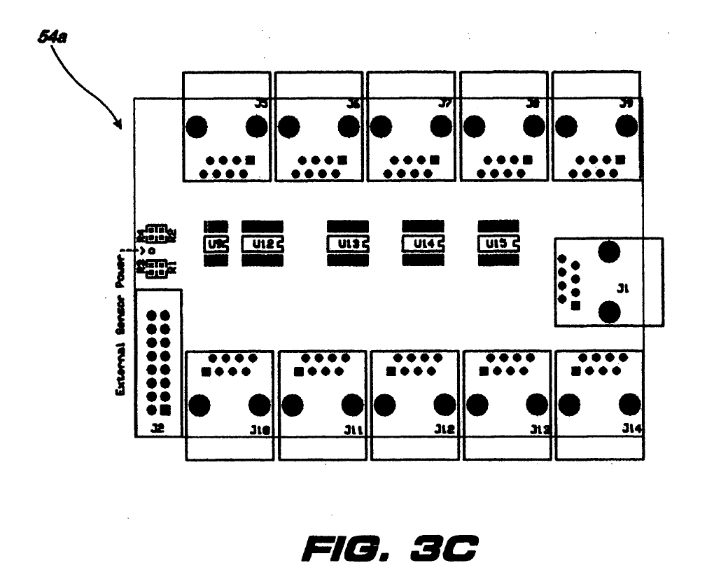

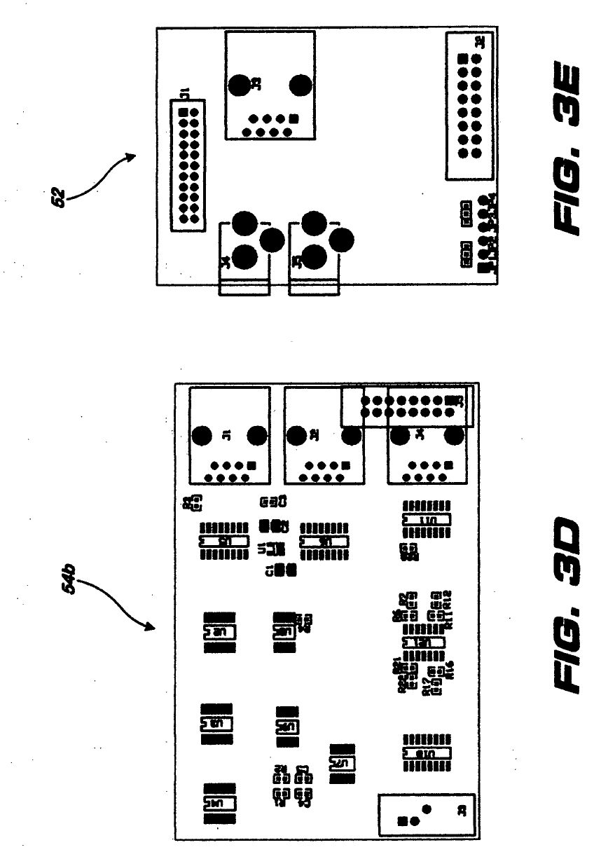

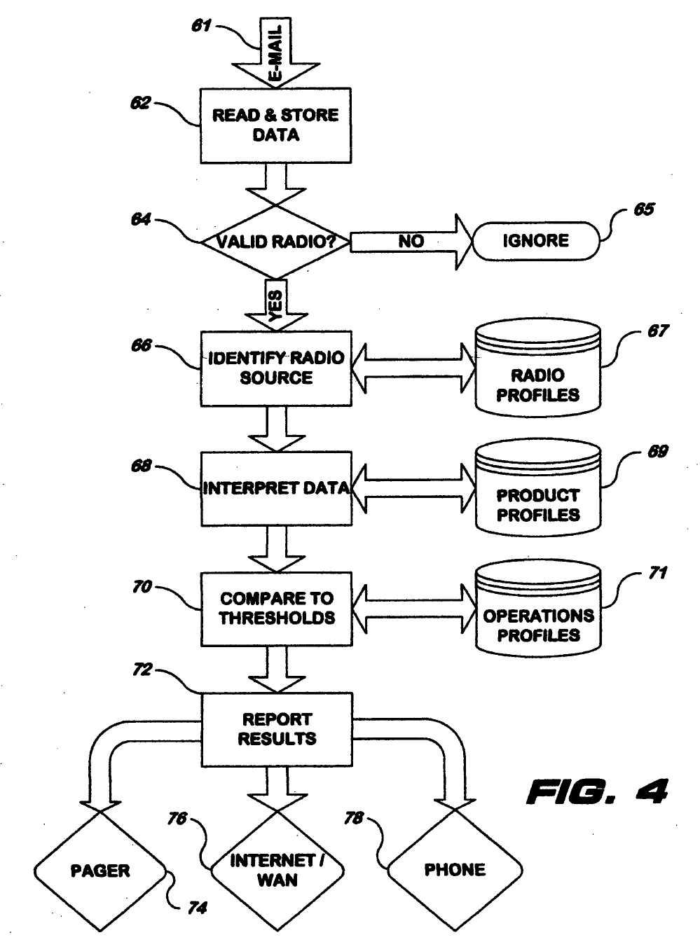

FIG. 3C is a schematic circuit board layout for a circuit board 54a that primarily performs the multiplexing function of the sensor input/output and multiplexing block functionally depicted in FIG. 3A. The multiplexer board 54a is a 64×2 de-multiplexer. Board 54a provides for selection and routing of 32 differential analog inputs to 1 differential analog output or 64 single-ended analog inputs to 2 single-ended analog outputs (or various combinations of both types of inputs). Ten RJ45 connectors (J5-J14) provide power and ground for external sensor excitation, and each contain connections for 3 differential inputs or 6 single ended inputs. This accounts for 60 of the possible 64 inputs. The remaining 4 inputs are connected to test voltages internally for testing purposes during manufacturing. The multiplexer board 54a is connected to the extender board 54b through a 10-pin ribbon connector J2. Power is provided by the extender board 54b to the multiplexer board 54a through connector J2. Connector J2 also connects the differential output of the multiplexer board 54a to the extender board 54b and provides 6 address lines, which are used to select one of the 32 inputs. The multiplexer board 54a includes a number of integrated circuits as follows:
U9 74HC00—Philips Quad 2-input NAND gate;
U12-U15 CD4067—Various Manufacturers: 16-channel Analog Multiplexer—Demultiplexer
   B. Extender Board 54b

FIG. 3D is a schematic circuit board layout for the extender board 54b, which primarily performs the sensor input/output function of the sensor input/output and multiplexing block 54 that is functionally depicted in FIG. 3A. The extender board 54b also provides an interface to the data communications board 50 via the power board, and also to the Multiplexer Board. The extender board accepts two analog input voltages (in this case from the multiplexing board 54a) and selects desired gain and signal routing. The amplified signals are routed to either an on board A/D converter or to the data communications board 50's on board A/D converter, depending on jumper selections and software configuration. The extender board 54b connects to the power board 52 and the data communications board 50 through one RJ45 connector J1 (on FIG. 3D). The other RJ45 connector J2 provides connection to other pairs of an extender board 54b and a multiplexing board 54a in a daisy chain fashion. The data communications board 50's input/output lines are multiplexed on these daisy chained RJ45 connectors to create serial peripheral interface links to three different devices (the power board 52, the multiplexing board and extender board pair 54, and the data communications board 50) while minimizing the number of interface lines required between extender boards. On the extender board, the two serial devices are an analog/digital converter and an 8-port serial shift register. The extender board 54b includes a number of integrated circuits as follows:
U1 TPS763XX—Texas Instruments 150-mA Low-Dropout Regulator
U2, U4 74AC299—Fairchild Semi-Conductor: 8-Input Universal Shift/Storage Register with Common I/O Pins
U3 74HC373—Phillips Semi-Conductor: Octal D-type transparent latch; 3-state
U5 CD4053—Various Manufacturers: Triple 2-channel Multi./Demultiplexer
U6 CD4052—Various Manufacturers: Differential 4channel Multiplexer -De-multiplexer
U7 AD7817—Analog Devices: Temperature Sensor (On Chip) 4-Channel, 9 μs, 10-Bit ADC
U8 74HC02—Phillips Semiconductor: Quad 2-input NOR gate
U9 74HC00—Phillips Semiconductor: Quad 2-input NAND gate
U10 CD4052—Various Manufactures: Differential 4-channel Multiplexer—De-multiplexer
U11 CD4052—Various Manufactures: Differential 4channel Multiplexer—De-multiplexer
U21 LM324—National Semiconductor: Low Power Quad Operational Amplifier

1. Shift Registers

Data is docked into shift register U2 via signals Data In and Clock. Simultaneously, data is clocked out of shift register U4 via signals Data Out and Clock. One shift register provides functionality of an 8-bit output port and the other shift register provides an 8-bit input port.

a. Address Port

The output of the U2 shift register is routed to the multiplexing board 54a acting as address lines to select the desired input sensor.

b. Input Port

Data on the input port is latched into the shift register via signal STROBE. Data is then clocked to the data communications board 50 using signals Data Out and Clock.

c. Control Port

The output of the U2 shift register is also connected to a latch U3. The STROBE signal latches data at the input of U3, effectively providing another 8-bit output port used for control of the extender board. Since, when writing data to the latch, the MUX selection changes as well, it is necessary to write data to the latch before selecting the desired MUX address.
Q0 general purpose output—currently unused
Q1 general purpose output—currently unused
Q2 A/D routing enable—activates U10 and U11 multiplexers used for gain selection of analog inputs
Q3, Q4 used to select Data Out and Data Out′ routing
   i. Data Out Routing
0,0 Input Shift register is routed to Data Out signal
0,1 Internal A/D is routed to Data Out signal
1,x Data In′ is routed to Data Out signal. (extender board acts as pass-thru)
   ii. Data Out′ Routing
0,0 Output Shift register is routed to Data Out′ signal
0,1 Data In is routed to Data Out signal (extender board acts as pass-thru)
1,x Q5, Q6 used to select amplifier gain routing
   Programmable Gain

The analog input signals have 4 possible routing selections. The selection is controlled by Q5 & Q6 of the control port. Amps B & C can be assembled to support either differential input or single ended input, but not both. This is done through proper resistor selection at the time of assembly. Amps A & D only support single ended input. All amps can have their gain and offset characteristics customized at time of assembly through proper resistor selection.
0,0 Differential input
   Input channel 1 & 2 routed through non inverting amp c and output on channel 1
   Input channel 1 & 2 routed through inverting amp b output on channel 2
0,1 Direct
   Input channel 1 routed directly to output channel 1 with no amp
   Input channel 2 routed directly to output channel 2 with no amp
1,0 Single ended Gain 1
   Input channel 1 routed through amp d to output channel 1
   Input channel 2 routed through amp b to output channel 2 (if configured for single ended input)
1,1 Single ended Gain 2
   Input channel 1 routed through amp c to output channel 1 (if configured for single ended input)
   Input channel 2 routed through amp a to output channel 2

1. A/D Conversion

A/D conversion can be made by the data communications board 50 or by the optional A/D converter on the extender board. When using the on board AID converter, Data In and a separate AID dock signal are used to dock data into the A/D converter. A/D dₒᵤₜ is routed to Data Out via U6 under control of Q3 and Q4 of the control port.

D. Power Board 52

The power board routes switched power to the data communications board 50 and provides a regulated output with pull-up resistors as required by the data communications board 50 interface. Two jumpers on the power board are used to control how the RJ45 interfaces to the 22 pin header. In one configuration, the analog input signals from the extender board are routed to the data communications board 50. In another configuration, these lines are used for control of the extender board's A/D.

E. The Data Communications Board 50

A suitable device for use as the data communications board 50 is the CreataLink2 XT device originally made and sold by Motorola and now marketed by SmartSynch, Inc. of Jackson, Miss. The Motorola Hardware Integrators Guide for Product Family 91B Data Transceiver dated May 16, 2000, describes the CreatALink2 XT essentially as follows:

The CreatAlink2 XT is a two-way data transceiver that supports the ReFLEX protocol. The CreataLink2 XT device can initiate transmissions into a ReFLEX Narrow Band Personal Communications System (NBPCS) network, receive and decode data, and store it. It can forward messages it receives from the ReFLEX network to an interconnected host device via an RS-232 level or Transistor-Transistor Logic (TTL) level serial port. The CreataLink2 XT device performs all necessary ReFLEX protocol processing to maintain connection to the ReFLEX network, accurately receives and acknowledges messages, and delivers messages in conformance with protocol requirements.

The CreataLink2 XT provides an 8-bit, bi-directional parallel Input/Output (I/O) port. Each bit can be configured individually as an input or output by the integrator or end-user. The product also has two Analog-to-Digital (A/D) input ports for customer use.

An additional pin is provided for a secondary battery source. This secondary source can be used to back-up RAM contents in the event of a power failure and can be selected through software to power the transmitter. The CreataLink2 XT device can support an off-board application configuration. In this configuration, off-board applications communicate with the CreataLink2 XT using the Communications Linking Protocol (CLP). The CreataLink2 XT also supports an on-board application configuration which enables third parties to write custom resident applications. This usually eliminates the need for an external application board.

One embodiment of a system according to the invention uses the CreatALink2 XT with certain on-board software enhancements as the data communications board 52.

F. Sofware for Data Communications Board 52

The two custom-designed functions programmed into the CreatALink2 XT version of the data communications board 50 are CLP_ApplicationInit and CLP_NotifyTimerExp. The following describes these functions.

```
/**********************************************************************
  *
  * Copyright (C) 2003 Ron Bane. All Rights Reserved
  *
  * FILE NAME :
  * DESCRIPTION : on_board application to control Extender Board
  *
  **********************************************************************/
```

1. The CLP_ApplicationInit Function

```
/**********************************************************************
  *
  * FUNCTION NAME : CLP_ApplicationInit
  *
  * PARAMETERS : Reset_Type -- identifies which type of reset has occurred
  * can be either HARD_RST or SOFT_RST
  *
  * DESCRIPTION : This module is supplied by the Developer. It is
  * called to allow the application to initialize
  *
  * RETURN : none
  *
  *
  **********************************************************************/
  //Configure and Initialize CreatAlink IO for extender boards
  //Signals are from the Extender Board perspective
```

| | | | |
|---|---|---|---|
| //HVIO_0 Data Out | Input | | |
| //HVIO_1 Data In | Output | low | |
| //HVIO_2 Clock | Output | high | idle |
| //HVIO_3 Strobe | Output | low | (data holds) |
| //HVIO_4 A/D Clock | Output | high | idle |
| //HVIO_5 Input Strobe | Output | high | |
| //HVIO_6 Power | Output | low | (off) |
| //HVIO_7 RTC select | Output | high | (deselected) |

```
//Initialize IO on extender boards
  //Send O's to all possible extender board shift registers
  //Latch O's in output register
  //Count # of daisy chained extender boards, by shifting a 1 through all
registers
```

Since Data Out′ is connected to Data In′ through a 100 k Ohm resistor, when there is only 1 extender board, the output which is clocked to the extender board will be clocked back in, in 16 clock cycles. 8 out and 8 back in. If 2 extender boards are daisy chained together, the output data will clock back in 32 clock cycles, etc.

2. The CLP_NotifyTimerExp Function

```
/**********************************************************************
  *
  * FUNCTION NAME : CLP_NotifyTimerExp
  *
  * PARAMETERS : Timer_Id -- identifies which timer expired
  *
```

| | |
|---|---|
| * DESCRIPTION : | This module is supplied by the Developer. It is |
| * | called when an application timer has expired. |

```
he state.
  *
  * RETURN : none
  *
  **********************************************************************/
    if (totalTickCount > ticks_between_messages)
    {
      totalTickCount = 0;
      if (XT_Sensor_Enable.TimeOfDay)
      {
        /* Get time of day */
        RTC_GetTime (&XT_TimeOfDay);
      }
      if (XT_Sensor_Enable.TempSensor)
      {
      /* get the current temperature */
      CLP_ReadAnalogPort(A_D_TEMP_ID, &XT_Temp);
    }
    if (XT_Sensor_Enable.Supply)
    {
      CLP_ReadAnalogPort(A_D_TXPWR_ID, &XT_Supply);
    }
    if (XT_Sensor_Enable.Channel_1)
    {
      CLP_ReadAnalogPort(A_D_EXT1_ID, &XT_Channel_1);
    }
    if (XT_Sensor_Enable.Channel_2)
    {
      CLP_ReadAnalogPort(A_D_EXT2_ID, &XT_Channel_2);
    }
    for (board=1; board <= XBD_gNumBoards; board++)
    {
      //Do Misc Sensors
      if (XTB_Sensor_Enable[board-1].TimeOfDay )
      {
        /* Get time of day */
        RTC_GetTime (&XTB_TimeOfDay[board-1]);
      }
      if (XTB_Sensor_Enable[board-1].TempSensor)
      {
      /* get the current temperature */
        error = XBD_ReadAnalogPort(board, XBD_AD_TEMP_ID, sensor,
NoMuxSensor[board-1], &XTB_Temp[board-1]);
      }
      if (XTB_Sensor_Enable[board-1].Internal_Reference)
      {
        error = XBD_ReadAnalogPort(board, XBD_AD_INTREF, sensor,
NoMuxSensor[board-1], &XTB_Internal_Reference[board-1]);
      }
      if (XTB_Sensor_Enable[board-1].Channel_1)
      {
        error = XBD_ReadAnalogPort(board, XBD_AD1_ID, sensor,
NoMuxSensor[board-1], &XTB_Channel_1[board-1]);
      }
      if (XTB_Sensor_Enable[board-1].Channel_2)
      {
        error = XBD_ReadAnalogPort(board, XBD_AD2_ID, sensor,
NoMuxSensor[board-1], &XTB_Channel_2[board-1]);
      }
      if (XTB_Sensor_Enable[board-1].Channel_3)
      {
        error = XBD_ReadAnalogPort(board, XBD_AD3_ID, sensor,
NoMuxSensor[board-1], &XTB_Channel_3[board-1]);
      }
      if (XTB_Sensor_Enable[board-1].Channel_4)
      {
        error = XBD_ReadAnalogPort(board, XBD_AD4_ID, sensor,
NoMuxSensor[board-1], &XTB_Channel_4[board-1]);
      }
      portId = XBD_AD1_ID;
      for (sensor=0; sensor < MAX_SENSORS; sensor++)
      {
        if (sensor == MAX_SENSORS/2)
        {
          portId = XBD_AD2_ID;
        }
        if (MuxSensor[board -1][sensor].enable)
        {
          error = XBD_ReadAnalogPort(board, portId, sensor,
MuxSensor[board-1][sensor], &MuxSensorData[board-1][sensor]);
        }
      } //end for sensor
    }// end for board
    error = XBD_Format_Output (reportBoard, Sample_Message);
    print_msg(1, (void*) Sample_Message, VARIABLE);
//  XBD_WriteParallelPort(1, 0xFF, 0x80);
    if (Control_State == RUNNING)
    {
      /* got the message, now we need to transmit the page */
      for (i=0; i<sizeof(msg); i++)
      msg[i] = 0x00;
      /* use sprintf to create the proper message format */
      sprintf((char *) msg, “%c%c%c%s%c%s”, bmo_sif, addr_start,
twoway_addr, Pin,
        addr_end, Sample_Message);
      /* load length parameter for CLP transmit message command */
      tmit_msg.msgLength = (UVAR16) strlen((char*) msg);
      /* set pointer to the message */
      tmit_msg.msgData = (UVAR8 *) msg;
      /* Transmit the message */
      error = CLP_TransmitMessage(&tmit_msg);
      if (error == COMMAND_SUCCESS)
      {
        /* transmit message command successfully queued the message for
transmission */
        print_msg(1, (void*) trans_success, sizeof(trans_success));
        Current_State = TRANS_MSG;
      }
      else
      {
        /* there was a problem with the transmit message command or
          * a transmission was already in progress, or unit is not
          * registered or is out of range */
        print_msg(1, (void*) trans_failed, sizeof(trans_failed));
        Current_State = IDLE;
      }
```

G. Server Software

FIG. 4 is a high-level flow diagram of exemplary steps taken by the server 60 in a system according to the invention when server 60 receives a report from a smart hub 30. As mentioned above, smart hubs 30 report information to server 60 as pages, which are preferably converted to e-mail 61, which is forwarded to server 60 by a server within the paging provider's control. This e-mail 61 contains information according to the description above that accompanies Tables 1-3. The server 60 first reads and stores the text of e-mail 61 at step 62 and checks in decision block 64 whether the e-mail 61 originated from a smart hub that is associated with this server 60. If not, the e-mail is simply ignored and deleted. If e-mail 61 did originate from an authorized smart hub 30, then server 60 determines at process 66 which smart hub 30 sent the message and retrieves the information associated with that smart hub from the radio profiles database 67. This database contains information that defines the reporting format for which the particular smart hub is configured and the other configuration information for the smart hub 30 discussed above. This database also contains information that links the particular smart hub to a physical location and a customer of the service provider so that the server can generate analysis and reports by location and by customer or by location within customer.

Server 60 then retrieves from the product profiles database 69 information about the items 10 that should be stored on display rack 20 associated with the particular smart hub. For example, the product profiles database 69 contains information about the weight of an individual item 10 to be displayed on the display rack 20. Using the information retrieved from the product profiles database 69, the server 60 can interpret sensor readings and compare these interpreted readings with operational thresholds that server 60 retrieves from the operations profiles database 71. The operations profiles database 71 contains for example the minimum number of items 10 that should be on display rack 20 before the inventory should be restocked. Another example of a threshold that may be retrieved from the operations profiles database 71 is the minimum rate at which items should be sold from display rack 20 given the cost of the space occupied by the display rack and other merchandising factors.

Once the server finishes analyzing the data in e-mail 61, it creates a set of standard reports using a conventional database and reporting software such as that from Crystal Reports, Oracle, or Sybase. These reports will illustrate how the inventory of items 10 on individual shelves 23 of particular display racks 20 has varied over time along with the current inventory of items 10 on these shelves 23. The report can also reflect sales of items 10 from individual shelves 23 during discrete time intervals. All this information can be sorted by display location, item type, shelf location, retailer, or any other field stored in the various databases discussed above. Because the system of the invention is highly flexible, the customer's requirements can drive the specific report types to be presented.

It will be apparent to those skilled in the art that various modifications and variations can be made in the system and method of sensing inventory levels and analyzing consumer buying habits that is described above without departing from the scope or spirit of the invention. Therefore, other embodiments of the invention will be apparent to those skilled in the art from their consideration of the specification and practice of the invention disclosed above. The applicants intend that the specification and examples be considered as exemplary only, with the true scope and spirit of the invention being indicated by the following claims.

1. A system for sensing inventory levels of an item on a display rack, comprising:
A. a means for sensing a characteristic of the items mounted on the display rack;
B. a means for retrieving item information from the sensing means;
C. a means for storing the item information retrieved by the retrieving means;
D. a means associated with the display rack for generating an electronic message based on selected portions of the item information stored in the storing means in which the message further includes a unique identifier that identifies the display rack to which the message is related;
E. a means for sending the message to a server over a wireless data communications network;
F. a means for receiving and storing the message sent by the sending means;
G. a means for determining whether the message originated from an authorized message generating means;
H. a means for storing the contents of the message in a database indexed at least by the unique identifier;
I. a means for analyzing the stored information for a particular message generating means to determine the current level of inventory of items on the display rack;
J. a means for comparing the current level of inventory of items on the display rack with an acceptable inventory level; and
K. a means for reporting the current inventory level to a distributor of the items that is responsible for maintaining the inventory of items above the acceptable level.
